(19) United States
(12) Patent Application Publication
(10) Pub. No.: US 2009/0265244 A1
(43) Pub. Date: Oct. 22, 2009

(54) METHODS AND APPARATUS FOR SURVEILLANCE AND TARGETED ADVERTISING

(76) Inventors: David M. Marmour, Maplewood, NJ (US); Haim Fleminger, Hofit (IL); Gad Shachar, Tenafly, NJ (US)

Correspondence Address: THE FARRELL LAW FIRM, LLP, 290 Broadhollow Road, Suite 210E, Melville, NY, 11747, US

(21) Appl. No.: 12/375,469

(22) PCT Filed: Jul. 27, 2007
(86) PCT No.: PCT/US07/74568

§ 371 Date: Jan. 28, 2009

Related U.S. Application Data
(60) Provisional application No. 60/834,270, filed on Jul. 28, 2006.

(51) Int. Cl. G06Q 30/00

(52) U.S. Cl. 705/14.58

(57) ABSTRACT

Methods and apparatus are shown for providing targeted media through video surveillance. One or more video streams are received at a computing system from one or more video cameras in a consumer environment. Content of at least one of the one or more video streams is analyzed at the computing system. Media content is selected in accordance with the analysis of the at least one of the one or more video streams. Media content is transmitted from the computing system to one or more monitors in the consumer environment.

### FIELD OF THE INVENTION

The present invention relates to a surveillance and media system and method of use and, more particularly, to a surveillance system that provides targeted media and advertising content to consumers.

### BACKGROUND OF THE INVENTION

There are approximately three million retail business establishments in the U.S. Approximately 90% of these establishments are considered small businesses, in that they have fewer than 20 employees. The small retail business establishment market is highly fragmented and consists mainly of small local businesses with limited access to resources and technology. Thus, it is estimated that between 60% and 80% of small retail business establishments are in need of some form of digital surveillance solution.

Surveillance systems in retail business establishments can decrease shoplifting by up to 53% and robberies by up to 73%. Further, such systems remind employees that they are under camera surveillance, thereby improving customer service. Digital video surveillance is the fastest growing niche within the surveillance market. Heightened security awareness by business owners, the return on investment (ROI) benefits of digital and Internet protocol (IP) solutions, and the need to replace mature surveillance technology are each driving the growth of the digital video surveillance market.

The small retail business establishment market is also ideal for digital signage utilizations. There is currently an ever increasing number of television channels, meaning each advertisement is reaching fewer viewers. Technology advancements in digital video recording permits viewers to bypass any advertising placed within a programming time slot. Digital signage provides a more effective sales and marketing tool that significantly increases advertised product sales. Due to the fact that brand managers wish to target specific consumers and also want to have the ability to measure marketing efforts, revenue for digital signage advertising has quickly increased.

Surveillance systems and digital signage have been provided for the small retail business market in the past, however the systems have failed to utilize the surveillance system input to benefit the digital signage output. Thus, no systems currently exist that utilize the surveillance system and media system to specifically increase sales via the advertising and media content capabilities of digital signage. Additionally, surveillance systems have typically been too expensive a venture for many small retail business establishments. A cost-effective system is needed that utilizes a digital surveillance system to provide greater advantage for advertisers and the small retail business establishment.

### SUMMARY OF THE INVENTION

The present invention, in illustrative embodiments thereof, provides a system and method for providing a surveillance system that provides targeted advertising and media content to consumers.

In accordance with one aspect of the present invention, methods and apparatus are shown for providing targeted media through video surveillance. One or more video streams are received at a computing system from one or more video cameras in a consumer environment. Content of at least one of the one or more video streams is analyzed at the computing system. Media content is selected in accordance with the analysis of the at least one of the one or more video streams. Media content is transmitted from the computing system to one or more monitors in the consumer environment.

In additional embodiments of the present invention, the computing system comprises a recording and media computing system in the consumer environment. The step of analyzing content may be conducted automatically at the recording and media computing system. A demographic report may be prepared at the recording and media computing system based on the analysis of the content of at least one of the one or more video streams. At least one of the demographic report and the one or more video stream may be transmitted from the recording and media computing system to at least one back office server. At least one of the demographic report and the one or more video streams may be analyzed at the at least one back office server. Media content may be selected automatically in accordance with the analysis of at least one of the demographic report and the one or more video streams. The media content may be transmitted from the at least one back office server to the one or more monitors via the Internet and the recording and media computing system.

In further embodiments of the present invention, the computing system comprises a remote computing system, and the one or more video streams may be received at the remote computing system through a recording and media computing system in the consumer environment. The step of analyzing content may be conducted manually by a user of the remote computing system. The step of selecting media content may be conducted manually by a user of the remote computing system.

In another aspect of the present invention, a surveillance and media system that comprises one or more video cameras in a consumer environment that transmit one or more video streams captured in the consumer environment. The system also includes at least one monitor displayed in the consumer environment that displays received media content, and at least one back office server that stores media content and transmits selected media content in accordance with an analysis of at least one of the one or more video streams. Finally, the system includes a recording and media computing system in the consumer environment that receives and records the at least one of the one or more video streams from the one or more video cameras, receives media content from the at least one server and transmits the media content for display on the one or more monitors.

In an additional aspect of the present invention, a recording and media computing system of a surveillance and media system is provided. The system comprises a surveillance system that receives one or more video streams from one or more cameras, records at least one of the one or more video streams, and a media system that receives media content from at least one back office server and transmits media content to one or more monitors.

In a further embodiment, the recording and media computing system may also comprise a demographics system that analyzes at least one of the one or more video streams, prepares a demographic report in accordance with the at least one of the one or more video streams and transmits the demographic report to the at least one back office server.

Finally, in another aspect of the present invention a surveillance and media business methodology is provided. An Internet connection, hardware and software are provided for the subscribing consumer environment, which are required for surveillance and media. Installation of the surveillance and media system in the subscribing consumer environment using the hardware, software and Internet connection is coordinated and conducted. Media slots for display in the subscribing consumer environment are sold. Advertisements corresponding to sold media slots are integrated into a media loop for display in the subscribing consumer environment. Advertisements are selected for display in the subscribing consumer environment in accordance with an analysis of a video stream of the surveillance and media system. Advertisers are charged in accordance with views of respective advertisements as determined by a demographic system of the surveillance and media system.

Other aspects and advantages of the present invention will become apparent from the following detailed description, taken in conjunction with the accompanying drawings, illustrating by way of example, the principles of the invention.

### BRIEF DESCRIPTION OF THE DRAWINGS

FIG. 1 is a diagram illustrating a surveillance and media system, according to an embodiment of the present invention;

FIG. 2 is a diagram illustrating a recording and media computing system, according to an embodiment of the present invention;

FIG. 3 is a flow diagram illustrating a targeted advertising and media content methodology through video surveillance, according to an embodiment of the present invention;

FIG. 4 is a flow diagram illustrating a targeted advertising and media content methodology through manual video surveillance, according to an embodiment of the present invention;

FIG. 5 is a flow diagram illustrating a surveillance and media business methodology, according to an embodiment of the present invention; and

FIG. 6 is a block diagram illustrating an exemplary hardware implementation of a computing system in accordance with which one or more components/methodologies of the invention may be implemented, according to an embodiment of the present invention.

### DETAILED DESCRIPTION OF THE INVENTION

The embodiments of the present invention provide methods and apparatus for surveillance and targeted media.

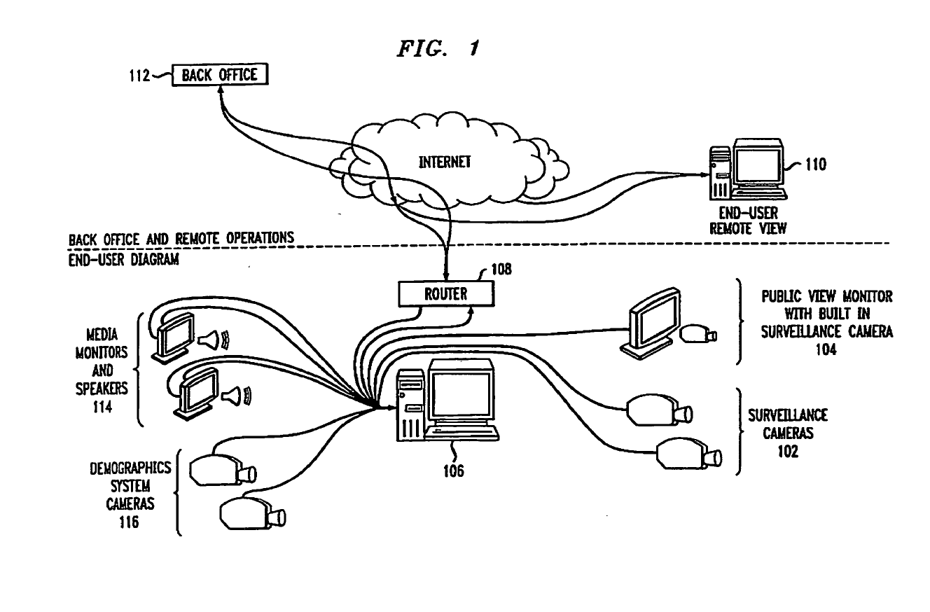

Referring initially to FIG. 1, a diagram illustrates a surveillance and media system, according to an embodiment of the present invention. Surveillance cameras 102 are positioned in a consumer environment such as, for example, a small retail business establishment. A zoom camera is preferably installed above a cash register of the store. A public view monitor with a built in surveillance camera 104 is preferably installed at the entrance of the store. The public view monitor 104 shows a real time view of the integrated camera and shows all who enter the store that they are under surveillance. Additional indoor and outdoor cameras may also be provided. For example, in an additional embodiment of the present invention, a pan/tilt/zoom camera may be installed in the ceiling at the center of the store. In a further embodiment, it is possible for the surveillance and media system to include only a single video camera. A video stream is transmitted from these cameras to a recording and media computing system 106.

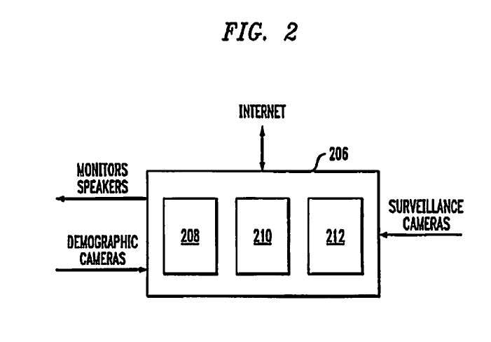

Recording and media computing system 106 preferably comprises a surveillance system, a media system and a demographics system, each of which will be described in further detail in FIG. 2. Recording and media computing system 106 may also only include the surveillance and media system. Recording and media computing system 106 is in communication with a router 108 or another device, which provides access to the Internet or another type of network. Router 108 may also be incorporated within recording and media system 106. Through the Internet, information may be provided to and received from a remote computing system 110 and a back office 112. Remote computing system 110 may be utilized by an owner of a consumer environment in order to access information on recording and media system 106. Back office 112 may consist of one or more servers in one or many different locations.

The surveillance and media system further includes media monitors and speakers 114, which receive input from recording and media system 106. Media monitors and speakers 114 are placed in the store in view of consumers. In a preferred embodiment of the present invention, the monitors are flat panel monitors. Recording and media computing system 106 is also preferably within the store in order to allow immediate on site access to information. Finally, the surveillance and media system includes one or more demographic system cameras 116, which feed video streams to recording and media system 106 for the purpose of demographic analysis of those in the consumer environment.

Referring now to FIG. 2, a diagram illustrates a recording and media computing system, according to an embodiment of the present invention. This may be considered a detailed description of element 106 of FIG. 1. Recording and media computing system 206 includes a surveillance system 208, a media system 210 and a demographics system 212.

Surveillance system 208 includes a digital video recorder that receives and records video feeds from surveillance cameras. Remote access and control of this system is available through the high speed Internet connection of recording and media computing system 206.

Media system 210 includes software that may be utilized to manage the use of media monitors and speakers. Advertising and media content may be downloaded via the high speed Internet connection of recording and media computing system 206 from remote computing system 110 and back office 112 of FIG. 1. Advertising and media content may include any media having at least one of audio and video that may be shown and heard in a consumer environment, such as, for example, advertising content, informational content, weather information, health information, news information, non-profit information. The media may be present in a standard or high definition format, and may also be interactive with consumers. Such advertising and other media content may be interactive by responding to queries posed by consumers or specifically addressing consumers with messages.

Demographics system 212 includes specialized recognition software such as, for example, software that maintains a count of consumers in the stores, and facial recognition software determining specific demographics of consumers. For example, the demographic system may determine that the majority of consumers in a store are women at one time of day and children at another time of day. Demographics are not limited to this example however, and may also include analysis based on such criteria as age, height, sex or race. Video input is analyzed, and a report may be transmitted through the high speed Internet connection of recording and media computing system 206 to back office 112 of FIG. 1.

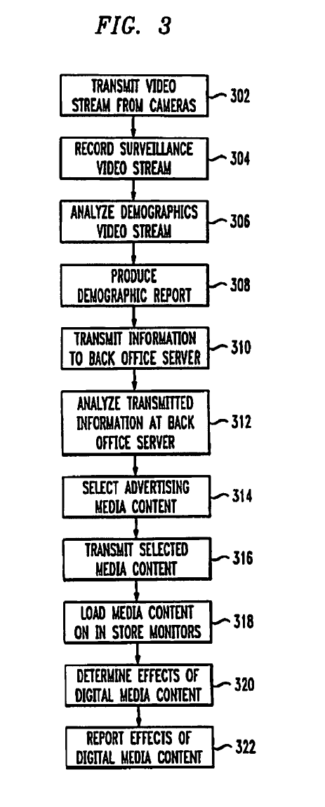

Referring now to FIG. 3, a flow diagram illustrates a targeted advertising and media content methodology through video surveillance, according to an embodiment of the present invention. The methodology begins in block 302, where a video stream is transmitted from the surveillance and demographic cameras to the recording and media computing system. In block 304, the surveillance system of the recording and media computing system records the received video streams from the surveillance cameras, preferably via the use of a digital video recorder as described above in FIG. 2. In block 306, the demographics system of the recording and media computing system analyzes the demographic video streams. This analysis may determine the number of consumers that are in the store, as well as specific demographics, such as, but not limited to age, sex and race, of the consumers currently within the store. In block 308, the demographics system of the recording and media computing system produces a demographic report as a result of the analysis. In block 310, information is transmitted from the recording and media system to the back office, preferably via the Internet. The transmitted information includes at least the demographics report. The remote computing system may also have access to the recorded video streams via the Internet connection.

In block 312, the back office analyzes the information transmitted from the recording and media system, in a preferred embodiment, the demographics report and the recorded video streams are analyzed. In block 314, advertising and any other media content is selected based on the analysis. In block 316, the selected advertising and any other media content is transmitted from the back office to the media system of the recording and media computing system. In block 318, the advertising and any other media content is loaded on media monitors and speakers in the store by the media system of the recording and media computing system. In block 320, the effects of the advertising and any other media content may be determined with respect to consumer activity in the consumer environment at the recording and media computing system via point of sale analysis. In block 322, the effects of the advertising and any other media content may be reported to a digital advertisement media provider or other entities from the recording and media computing system, via the Internet.

In accordance with a further aspect of the present invention described in FIG. 3, the demographic video stream may be automatically analyzed and a demographic report may be produced at the back office.

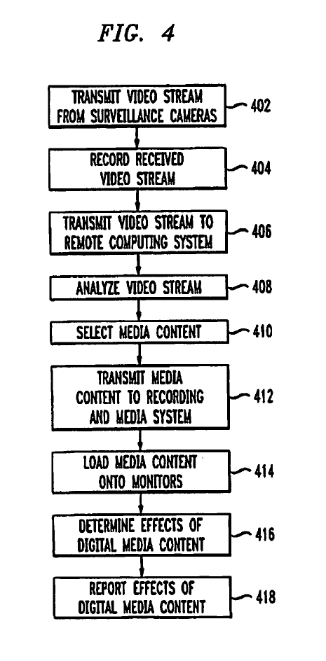

Referring now to FIG. 4 a flow diagram illustrates an alternate targeted media methodology through video surveillance, according to an embodiment of the present invention. The methodology begins in block 402 where video streams are transmitted from surveillance cameras to the surveillance system of the recording and media computing system. In block 404, the digital video recorder of the surveillance system records the video steams from surveillance cameras. In block 406, the video stream is transmitted from the recording and media computing system to a remote computing system, preferably through the Internet.

In block 408, content in the video stream is analyzed at the remote computing system. The analysis may include a determination of demographics of customers currently in the store, or a count of the number of customers in the store. This analysis may be performed manually by a user of the remote computing system. In block 410, advertising and any other media content is selected based on the analysis of the video feed at the remote computing server. The advertising and any other media content is targeted specifically for consumers currently in the store. This selection may be performed manually by a user of the remote computing system.

In block 412, advertising and any other media content is transmitted from a back office to a media player of the media system in the recording and media computing system through the Internet. In block 414, the advertising and any other media content is transmitted from the media player of the recording and media computing system to media monitors and speakers placed throughout the store. In block 416, the effects of the advertising and any other media content may be determined with respect to consumer activity in the consumer environment at the recording and media computing system. In block 418, the effects of the digital media may be reported to a digital advertisement media provider or other entities from the recording and media computing system, via the Internet.

In accordance with a further aspect of the present invention described in FIG. 4, the video stream may instead be transmitted to the back office where the video stream is manually analyzed and advertising and any other media content is manually selected by a user at the back office.

The methodologies of FIGS. 3 and 4 may be provided simultaneously to a plurality of consumer environments. More specifically, a single back office may act as a media supplier for a plurality of consumer environments, each running one of the methodologies above.

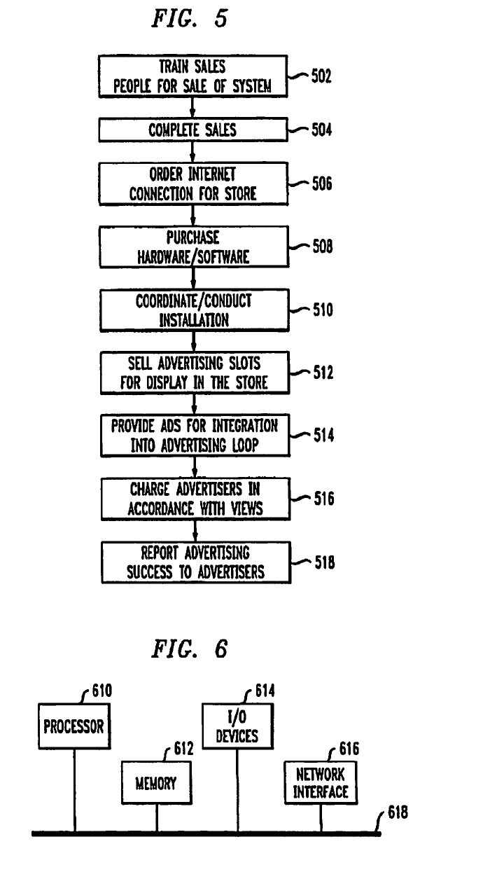

Referring now to FIG. 5 a flow diagram illustrates surveillance and media business methodology, according to an embodiment of the present invention. The methodology begins in block 502, where a sales people are trained for the marketing and sale of the surveillance and media system. In block 504, sales are completed by sales people to small retail business establishments. Completed and executed sales contracts are returned and processed. A completed sale indicates that a retail business establishment has agreed to pay an affordable monthly fee for a surveillance system that provides targeted media to consumers. The system further provides a designated number of media spots, Internet access and a warrantee for a specified time period.

In block 506, an Internet connection is ordered for the respective store. In block 508, hardware and software are purchased for the store. Logistic services vendor is updated with details of incoming hardware and software, system programming data and store information, such as its address. In block 510, installation is coordinated and conducted. Equipment is configured and repackaged by logistics vendor and shipped to installer. A third-party subcontractor coordinated by master sub-contractor organizations conducts installation. Installers install systems in the presence of the end-user. Upon completion of the installation, the end-user confirms the satisfactory installation verbally and in writing to a customer service representative.

In block 512, media slots are sold for the installed system in the store. In block 514, ad content is provided for integration into the media loop. The content loop is loaded onto servers and is fed, via the Internet, to the individual end-user locations. In block 516, charge advertisers based on number of consumers viewing the displayed ads, which is determined by the demographics/surveillance system. The demographics/surveillance system reports allows for the targeting of ads and content to specific store locations at specific times. In block 518, the targeting and successfulness of targeting advertisements is reported to the advertisers or other entities.

It is to be appreciated that the system and methodology of the present invention may be implemented in other environments aside from consumer environments for the purposes of targeting media to people within the environment.

Referring now to FIG. 6, a block diagram illustrates an exemplary hardware implementation of a computing system in accordance with which one or more components/methodologies of the invention (e.g., components/methodologies described in the context of FIGS. 1-6) may be implemented, according to an embodiment of the present invention.

As shown, the computer system may be implemented in accordance with a processor 610, a memory 612, I/O devices 614, and a network interface 616, coupled via a computer bus 618 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of providing targeted media through video surveillance comprising the steps of:
receiving one or more video streams at a computing system from one or more video cameras in a consumer environment;
analyzing content of at least one of the one or more video streams at the computing system;
selecting media content in accordance with the analysis of the at least one of the one or more video streams; and
transmitting media content from the computing system to one or more monitors in the consumer environment.

2. The method of claim 1, wherein the computing system comprises a recording and media computing system in the consumer environment.

3. The method of claim 2, wherein the step of analyzing content is conducted automatically at the recording and media computing system.

4. The method of claim 3, wherein the step of analyzing content comprises the steps of:
preparing a demographic report at the recording and media computing system based on the analysis of the content of the at least one of the one or more video streams; and
transmitting at least one of the demographic report and the one or more video streams from the recording and media computing system to at least one back office server.

5. The method of claim 4, wherein at least one of the demographic report and the one or more video streams is transmitted via the Internet.

6. The method of claim 4, wherein the step of selecting media content comprises the steps of:
analyzing at least one of the demographic report and the one or more video streams at the at least one back office server; and
selecting media content automatically in accordance with the analysis of at least one of the demographic report and the one or more video streams.

7. The method of claim 6, wherein, in the step of transmitting media content, the media content is transmitted from the at least one back office server to the one or more monitors via the Internet and the recording and media computing system.

8. The method of claim 1, wherein the computing system comprises a remote computing system, and wherein, in the step of receiving one or more video streams, the one or more video streams are received at the remote computing system via a recording and media computing system in the consumer environment.

9. The method of claim 8, wherein the step of analyzing content is conducted manually by a user of the remote computing system.

10. The method of claim 8, wherein the step of selecting media content is conducted manually by a user of the remote computing system.

11. The method of claim 1, wherein:
the computing system comprises at least one back office server;
in the step of receiving one or more video streams, the one or more video streams are received at the at least one back office server via a recording and media computing system in the consumer environment;
the step of analyzing content is conducted automatically at the at least one back office server; and
the step of selecting media content is conducted automatically at the at least one back office server.

12. The method of claim 1, wherein:
the computing system comprises at least one back office server;
in the step of receiving one or more video streams, the one or more video streams are received at the at least one back office server via a recording and media computing system in the consumer environment;
the step of analyzing content is conducted manually by user of the at least one back office server; and
the step of selecting media content is conducted manually by a user of the at least one back office server.

13. The method of claim 1, wherein the step of receiving one or more video streams comprises the step of recording at least one of the one or more video streams at a recording and media computing system.

14. The method of claim 1, wherein the step of analyzing content comprises the step of determining demographic information of one or more consumers from at least one of the one or more video streams in the consumer environment.

15. The method of claim 1, wherein the step of analyzing content comprises the step of determining a number of consumers in the consumer environment via at least one of the one or more video streams.

16. The method of claim 1, wherein, in the step of selecting media content, the media content is selected to target one or more consumers in the consumer environment.

17. The method of claim 1, wherein, in the step of transmitting media content, the media content is transmitted from at least one back office server to a recording and media computing system, and from the recording and media computing system to the one or more monitors in the consumer environment.

18. The method of claim 1, further comprising the steps of:
determining effects of the media content with respect to consumer activity in the consumer environment; and
preparing and providing a report to advertisers regarding the effects of the media content in the consumer environment.

19. A surveillance and media system comprising:
one or more video cameras in a consumer environment that transmit one or more video streams captured in the consumer environment;
at least one monitor displayed in the consumer environment that displays received media content;
at least one server that stores media content and transmits selected media content in accordance with an analysis of at least one of the one or more video streams; and
a recording and media computing system in the consumer environment that receives and records the at least one of the one or more video streams from the one or more video cameras, receives media content from the at least one server and transmits the media content for display on the one or more monitors.

20. The surveillance and media system of claim 19, further comprising at least one remote computing system that receives at least one of the one or more video streams from the recording and media computing system and allows for selection of media content from the at least one server.

21. A recording and media computing system of a surveillance and media system comprising:
a surveillance system that receives one or more video streams from one or more video cameras and records at least one of the one or more video streams; and
a media system that receives media content selected in accordance with an analysis of at least one of the one or more video streams and transmits the media content to one or more monitors.

22. The recording and media computing system of claim 20, further comprising a demographics system that analyzes at least one of the one or more video streams, prepares a demographic report in accordance with the at least one of the one or more video streams and transmits the demographic report to at least one back office server.

23. The recording of media computing system of claim 21, further comprising a router for transmission of information through and reception of information from the Internet.

24. Apparatus for providing targeted media through video surveillance, comprising:
a memory; and
at least one processor coupled to the memory and operative to: (i) receive one or more video streams at a computing system from one or more video cameras in a consumer environment; (ii) analyze content of at least one of the one or more video streams at the computing system; (iii) selecting media content in accordance with the analysis of the at least one of the one or more video streams; and (iv) transmit media content from the computing system to one or more monitors in the consumer environment.

25. A method for providing targeted media through video surveillance, the method comprising the steps of:
instantiating first computer instructions onto a computer readable medium, the first computer instructions configured to receive one or more video streams at a computing system from one or more video cameras in a consumer environment;
instantiating second computer instructions onto a computer readable medium, the second computer instructions configured to analyze content of at least one of the one or more video streams at the computing system;
instantiating third computer instructions onto a computer readable medium, the third computer instructions configured to selecting media content in accordance with the analysis of the at least one of the one or more video streams; and
instantiating fourth computer instructions onto a computer readable medium, the further computer instructions configured to transmit media content from the computing system to one or more monitors in the consumer environment.

26. A method of providing surveillance and media to a consumer environment comprising the steps of:
providing an Internet connection for a subscribing consumer environment;
providing hardware and software for the subscribing consumer environment required for surveillance and media;
coordinating and conducting installation of the surveillance and media system in the subscribing consumer environment using the hardware, software and Internet connection;
selling media slots for display in the subscribing consumer environment;
integrating advertisements corresponding to sold media slots into a media loop for display in the subscribing consumer environment;
selecting advertisements and content for display in the subscribing consumer environment in accordance with an analysis of a video stream of the surveillance and media system;
charging advertisers in accordance with views of respective advertisements as determined by a demographic system of the surveillance and media system; and
providing a report to advertisers regarding the success rate of advertisements in the consumer environment.
